(19) United States
(12) Patent Application Publication
(10) Pub. No.: US 2026/0142085 A1
(43) Pub. Date: May 21, 2026

(54) MULTILAYER ELECTRONIC COMPONENT

(71) Applicant: Murata Manufacturing Co., Ltd., Nagaokakyo-shi (JP)

(72) Inventor: Naoki MIKATA, Nagaokakyo-shi (JP)

(21) Appl. No.: 19/386,570

(22) Filed: Nov. 12, 2025

(30) Foreign Application Priority Data
Nov. 18, 2024 (JP) 2024-200748

(51) Int. Cl. H01G 4/232; H01G 2/06; H01G 4/008; H01G 4/012; H01G 4/30

(52) U.S. Cl. CPC H01G 4/2325; H01G 2/065; H01G 4/008; H01G 4/012; H01G 4/30

(57) ABSTRACT

A multilayer electronic component includes a multilayer body and external electrodes each located on a corresponding one of a third surface or a fourth surface of the multilayer body. The external electrodes each include a Ni plated layer and an Au plated layer on the Ni plated layer. Gaps exist between the Ni plated layer and the Au plated layer. An existence ratio of the gaps is about 0.05% or less.

### CROSS REFERENCE TO RELATED APPLICATIONS

This application claims the benefit of priority to Japanese Patent Application No. 2024-200748 filed on Nov. 18, 2024. The entire contents of this application are hereby incorporated herein by reference.

### BACKGROUND OF THE INVENTION

### 1. Field of the Invention

The present invention relates to multilayer electronic components.

### 2. Description of the Related Art

Multilayer electronic components are often mounted on a substrate by solder or the like. However, multilayer electronic components may be adversely affected by flux included in solder. For this reason, multilayer electronic components are sometimes mounted by wire bonding (see, for example, Japanese Unexamined Utility Model Application, Publication No. H5-4451).

However, when a multilayer electronic component is mounted by wire bonding via an external electrode, the wire attached by wire bonding sometimes detaches from the external electrode.

### SUMMARY OF THE INVENTION

Example embodiments of the present invention provide multilayer electronic components each with improved connectivity between an external electrode and a wire.

An example embodiment of the present invention provides a multilayer electronic component that includes a multilayer body including a first surface and a second surface opposed to each other in a lamination direction, a third surface and a fourth surface opposed to each other in a first direction intersecting the lamination direction, and a fifth surface and a sixth surface opposed to each other in a second direction intersecting the lamination direction and the first direction, and external electrodes each located on a corresponding one of the third surface or the fourth surface of the multilayer body. The external electrodes each include a Ni plated layer and an Au plated layer on the Ni plated layer. Gaps exist between the Ni plated layer and the Au plated layer. An existence ratio of the gaps is about 0.05% or less.

Another example embodiment of the present invention provides a multilayer electronic component that includes a multilayer body including a first surface and a second surface opposed to each other in a height direction, a third surface and a fourth surface opposed to each other in a first direction intersecting the height direction, and a fifth surface and a sixth surface opposed to each other in a second direction intersecting the height direction and the first direction, and external electrodes each located on a corresponding one of the third surface or the fourth surface of the multilayer body. The external electrodes are also located on the first surface, the second surface, the fifth surface and the sixth surface, in addition to the third surface or the fourth surface. The external electrodes on the first surface each include a Ni plated layer and an Au plated layer provided on the Ni plated layer. Gaps exist between the Ni plated layer and the Au plated layer. An existence ratio of the gaps is about 0.05% or less.

According to example embodiments of the present multilayer electronic components each with improved reliability of wire bonding to an external electrode during wire bonding are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view taken along the line I-I of the multilayer ceramic capacitor 1 in FIG. 1, and also shows a state in which the capacitor is mounted on a substrate 100 and wire-bonded.

FIG. 3 is a diagram showing an image of a binarized image of a Ni plated layer.

FIG. 4 is a flowchart showing a method of manufacturing the multilayer ceramic capacitor 1 according to an example embodiment of the present invention.

FIGS. 5A and 5B are diagrams showing a wire bonding method.

FIG. 6 is a table showing the results of evaluation of peeling of an Au plated layer of the multilayer ceramic capacitor 1.

FIG. 7 is a schematic perspective view of a multilayer ceramic capacitor 1A according to another example embodiment of the present invention.

FIG. 8 is a cross-sectional view taken along the line II-II of the multilayer ceramic capacitor 1A in FIG. 7, and also shows a state in which the capacitor is mounted on a substrate 100 and wire-bonded.

### DETAILED DESCRIPTION OF THE EXAMPLE EMBODIMENTS

Example embodiments of the present invention will be described in detail below with reference to the drawings.

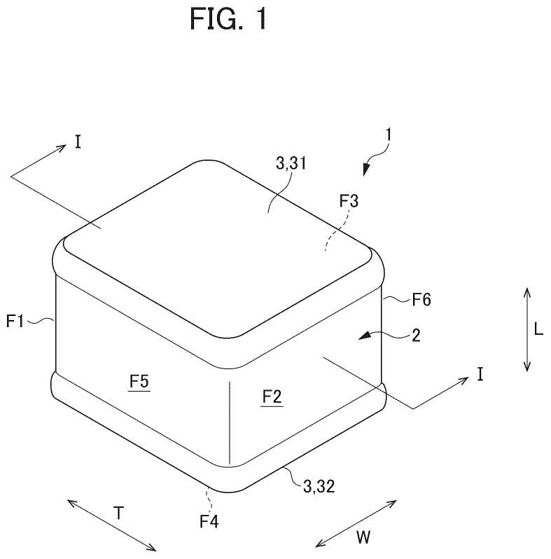

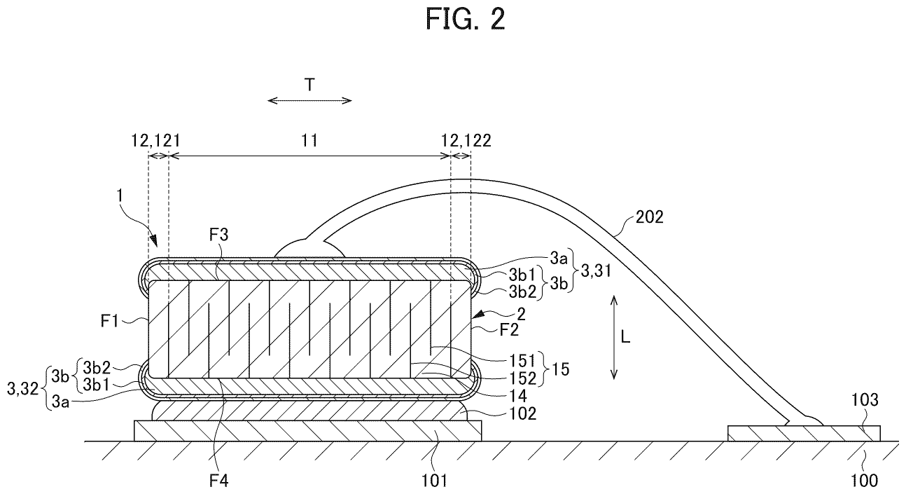

Hereinafter, a multilayer ceramic capacitor 1 will be described as an example embodiment of a multilayer electronic component of the present invention. FIG. 1 is a schematic perspective view of the multilayer ceramic capacitor 1. FIG. 2 is a cross-sectional view taken along the line I-I of the multilayer ceramic capacitor 1 in FIG. 1, and also shows a state in which the multilayer ceramic capacitor 1 is mounted on a substrate 100 and wire-bonded.

The multilayer ceramic capacitor 1 includes a multilayer body 2 and a pair of external electrodes 3 each provided on a corresponding one of a third surface F3 and a fourth surface F4. The third surface F3 and the fourth surface F4 of the multilayer body 2 are opposed to each other.

In the following description, as terms indicating the orientation of the multilayer ceramic capacitor 1, the direction in which the dielectric layers 14 and the internal electrode layers 15 are laminated is defined as the lamination direction T. In the multilayer ceramic capacitor 1, the direction that intersects the lamination direction T and in which the pair of external electrodes 3 are provided is defined as a first direction L. The direction that intersects both the first direction L and the lamination direction T is defined as a second direction W. In addition, in the present example embodiment, the lamination direction T, the first direction L, and the second direction W are orthogonal or substantially orthogonal to each other.

As shown in FIG. 2, a second external electrode 32 on the fourth surface F4 of the multilayer ceramic capacitor 1 is attached to a first land 101 provided on one surface of the substrate 100 via an electrically conductive adhesive 102.

The multilayer body 2 includes an inner layer portion 11 and two outer layer portions 12 that sandwich the inner layer portion 11 from both sides in the lamination direction T. The inner layer portion 11 includes a plurality of sets of dielectric layers 14 and internal electrode layers 15.

In this specification, among the six outer surfaces of the multilayer body 2 shown in FIG. 1, a pair of outer surfaces opposed to each other in the lamination direction T are defined as a first surface F1 and a second surface F2, a pair of outer surfaces opposed to each other in the first direction L are defined as a third surface F3 and a fourth surface F4, and a pair of outer surfaces opposed to each other in the second direction W are defined as a fifth surface F5 and a sixth surface F6. In addition, the surface of the multilayer body 2 may be roughened.

A portion where two surfaces among the first surface F1, the second surface F2, the third surface F3, the fourth surface F4, the fifth surface F5, and the sixth surface F6 intersect is referred to as a ridge portion, and a portion where three surfaces intersect is referred to as a corner portion. It is preferable that the ridge portions and the corner portions are rounded, and the rounding prevents chipping. When the ridge portions and the corner portions are rounded, the surfaces excluding the corner portions and the ridge portions may be flat.

The inner layer portion 11 includes first internal electrode layers 151 each including one end exposed on the third surface F3, second internal electrode layers 152 each including one end exposed on the fourth surface F4, and dielectric layers 14 alternately laminated with the first internal electrode layers 151 and the second internal electrode layers 152.

The dielectric layers 14 each include a first region that covers one end in the first direction L of the first internal electrode layer 151 and the second internal electrode layer 152 that is not exposed at the third surface F3 or the fourth surface F4, and a second region that covers at least a portion of one surface in the lamination direction T of the first internal electrode layer 151 and the second internal electrode layer 152. That is, the first region indicates a portion between the first internal electrode layer 151 and the fourth surface F4, and a portion between the second internal electrode layer 152 and the third surface F3. The second region covers at least a portion of the surface adjacent to the first surface F1 of each of the first internal electrode layer 151 and the second internal electrode layer 152.

It is preferable that the dielectric component included most in the first region and the dielectric component included most in the second region are of the same type. The dielectric component includes, for example, components such as Ba, Ti, Ca, Zr, and Sr, but is not limited thereto. For example, when a large amount of CaTiO₃ or CaZrO₃ is included as the dielectric component, it is possible to reduce or prevent dielectric breakdown from occurring between the end portion in the first direction L of the first internal electrode layer 151 and the second external electrode 32, and between the first internal electrode layer 151 and the second internal electrode layer 152. In addition, the present invention is not limited thereto, and, for example, SrTiO₃ or the like can also be used as a main component.

Furthermore, it is preferable that the second region is made of a material having a high permittivity, for example, BaTiO₃, in order to increase the capacitance of the multilayer ceramic capacitor 1.

The internal electrode layers 15 each include a counter region where the first internal electrode layer 151 and the second internal electrode layer 152 are opposed to each other, and an extension region that extends from the counter region toward the third surface F3 or the fourth surface F4 and is exposed at the third surface F3 or the fourth surface F4. Furthermore, each of the internal electrode layers 15 may have a width that changes as it approaches an exposed one end of the internal electrode.

As components of the first internal electrode layers 151 and the second internal electrode layers 152, for example, appropriate electrically conductive materials such as metals including Ni, Cu, Ag, Pd, Au, Sn, or alloys including at least one of these metals, such as Ag-Pd alloy may be used. However, the present invention is not limited thereto. Furthermore, by including, for example, a Sn layer at the interface between the first internal electrode layer 151 and the second internal electrode layer 152 and the dielectric layer 14, electric field concentration at the interface can be reduced or prevented, leading to improved high-temperature load reliability. At this time, even if Sn is included in only either one of the internal electrode layers 15 among the first internal electrode layer 151 and the second internal electrode layer 152, it is still possible to sufficiently provide this advantageous effect.

When a region between the first internal electrode layer 151 and the fifth surface F5 and a region between the second internal electrode layer 152 and the fifth surface F5 are defined as a fifth surface-side region, and when a region between the first internal electrode layer 151 and the sixth surface F6 and a region between the second internal electrode layer 152 and the sixth surface F6 are defined as a sixth surface-side region, Si segregation may be present in the fifth surface-side region and the sixth surface-side region existing on both sides of these internal electrode layers 15 in the second direction W. This makes it possible to improve the flexural strength of the multilayer ceramic capacitor 1.

The outer layer portion 12 includes a first outer layer portion 121 and a second outer layer portion 122. The first outer layer portion 121 and the second outer layer portion 122 are each made of an insulating material. When the outer layer portion 12 is made of the same type of dielectric material as the first region and the second region of the dielectric layer 14, each outer layer portion 12 may include a plurality of outer dielectric layers or may include a single outer dielectric layer. It is also possible to configure the dielectric layer 14 and the outer layer portion 12 with different components. For example, it is possible to make the dielectric layer 14 have a higher permittivity than the outer layer portion 12, and to change the outer layer portion 12 with components with better moisture resistance, weather resistance, and strength resistance. However, the present invention is not limited thereto, and, for example, the outer layer portion 12 may be made of a DLC film or may be made of a different type of insulating material such as an insulating resin.

The external electrode 3 includes a first external electrode 31 provided on the third surface F3 and a second external electrode 32 provided on the fourth surface F4. It is preferable that each of the external electrodes 3 further extends to the first surface F1, the second surface F2, the fifth surface F5, and the sixth surface F6. The first external electrode 31 and the second external electrode 32 each include a base electrode layer 3a and a plated layer 3b.

In the present example embodiment 1, the base electrode layer 3a includes, for example, a metal component and a glass component. It is preferable that the base electrode layer 3a includes, for example, Cu as a main component. However, the base electrode layer 3a may include other metal components and glass components in addition to Cu. Examples of the glass component include oxides of Ba, Sr, Si, Ca, Zn, Al, B or the like. Examples of other metal components that may be included are Mg, Cr, Sr, Al, Na, Fe, or the like.

As Modified Example 1, the base electrode layer 3 a may include, for example, a metal component and a dielectric component of the same type as the dielectric layer 14. This makes it possible to form the multilayer body 2 and the base electrode layer 3a by co-firing.

As Modified Example 2, the base electrode layer 3 a may include, for example, an electrically conductive component and a resin component. This makes it possible to reduce or prevent the occurrence of cracks due to the stress relaxation effect of the resin.

As Modified Example 3, the base electrode layer 3 a may include, for example, a plated layer including about 99% by volume or more of a metal component. In that case, the plated layer is directly connected to the internal electrode layer 15.

In the present example embodiment, a plated layer 3b provided on the outer side of the base electrode layer 3a preferably includes at least two or more layers, and includes, for example, an Au plated layer 3b2 on the outermost surface. In the present example embodiment, for example, the plated layer 3b includes a Ni plated layer 3b1 and an Au plated layer 3b2 in order from the base electrode layer 3a. When the Au plated layer 3b2 is provided on the outermost surface, it is possible to improve the Au wire bonding property.

The plated layer 3b preferably does not include glass. The metal ratio per unit volume of the plated layer 3b is, for example, preferably about 99% by volume or more.

Further, the thickness of the Ni plated layer 3b1 can preferably be, for example, about 0.8 μm or more and about 6.0 μm or less. Further, the thickness of the Au plated layer 3b2 can preferably be, for example, about 0.3 μm or more and about 1.1 μm or less.

The dimensions of the multilayer ceramic capacitor 1 including the external electrode 3 are not particularly limited. The dimensions of the multilayer ceramic capacitor 1 including the external electrode 3 can be, for example, about 0.40±0.02 mm in the first direction L, about 0.20±0.02 mm in the second direction W, and about 0.20±0.02 mm in the lamination direction T.

In the multilayer ceramic capacitor 1 of the present example embodiment, gaps exist between the Ni plated layer 3b1 and the Au plated layer 3b2 provided on the Ni plated layer 3b1. The gaps are provided in void portions in the Ni plated layer 3b1. The voids each refer to a portion in the Ni plated layer 3b1 where Ni plating is not provided, or a portion where Ni plating is provided but is thinner than other portions and is observed as a recess.

The gaps are provided by the Au plated layer 3b2 covering the void portions of the Ni plated layer 3b1. That is, the void portions in the Ni plated layer 3b1 correspond to the gaps between the Ni plated layer 3b1 and the Au plated layer 3b2.

Viewing the plated layer 3b from a direction perpendicular or substantially perpendicular to the surface thereof is referred to as a plan view. In the plan view, the shape of the gap matches the shape of the void that defines the gap. That is, the shape and size of each of the gaps observed in the plated layer 3b in the plan view are the same or substantially the same as the shape and size of each of the voids observed in the Ni plated layer 3b1 after removing the Au plated layer 3b2.

In the multilayer ceramic capacitor 1 of the present example embodiment, for example, the existence ratio of gaps is about 0.10% or less. Preferably, the existence ratio of gaps is about 0.05% or less, for example. More preferably, the existence rate of gaps is about 0.01% or more and about 0.05% or less, for example.

By setting the existence ratio of gaps to about 0.05% or less, it is possible to improve the connectivity between the external electrodes. On the other hand, when the existence ratio of gaps exceeds about 0.05%, it is not possible to improve the reliability of wire bonding performed on the external electrode. In portions where gaps exist, the connection of wire bonding to the external electrode tends to be unstable. This is because, in portions where gaps exist, sufficient force to connect the wire to the external electrode may not be applied during bonding. Further, this is because the Au plated layer 3b2 may delaminate in portions where gaps exist.

Further, by setting the existence ratio of gaps to about 0.01% or more, it is possible to improve the moisture resistance of the multilayer ceramic capacitor 1. Setting the existence ratio of gaps to about 0.01% or more indicates that the number of voids in the Ni plated layer 3b1 is not reduced to zero, but rather some voids exist. The existence of voids increases the adhesion area between the Ni plated layer 3b1 and the Au plated layer 3b2. This improves the sealing property between the Ni plated layer 3b1 and the Au plated layer 3b2. As a result, it is possible to improve the moisture resistance of the multilayer ceramic capacitor 1.

An example of a method for determining the existence ratio of gaps will be described. The existence ratio of gaps can be determined by image processing. First, the Au plated layer 3b2 is delaminated from the plated layer 3b to expose the Ni plated layer 3b1. Next, the surface of the exposed Ni plated layer 3b1 is observed with an FE-SEM (field emission scanning electron microscope).

The observation conditions are as follows: the observation magnification is about 10,000 times, the acceleration voltage is about 10 kV, and secondary electrons generated from the sample are detected. Thus, an SEM image of the surface of the Ni plated layer 3b1 is obtained.

Next, the SEM image is subjected to image processing. First, as preprocessing of the image, noise is removed from the image as necessary. Noise removal can be performed using filtering processing included in image processing software, for example.

Next, binarization processing is performed. Specifically, the contrast between void portions and Ni plated portions is binarized. The threshold between white and black is set to about 50%. That is, the threshold is set to 128 gradations in the case of 256 gradations, for example.

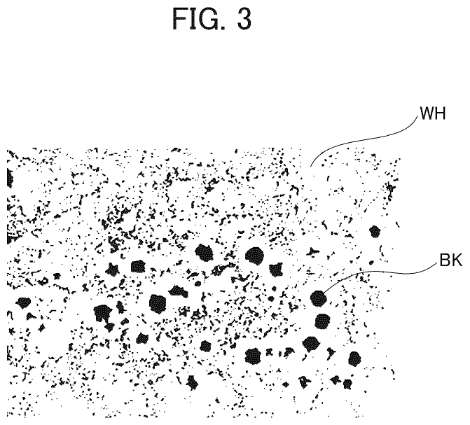

FIG. 3 shows an image of the Ni plated layer after binarization. FIG. 3 is a diagram showing an image of the binarized image. In addition, FIG. 3 is not an image after binarization of the Ni plated layer of the present example embodiment, but is merely an image for explanation. The white portions WH in FIG. 3 indicate the Ni plated portions. The black portions BK in FIG. 3 indicate the void portions.

The existence ratio of gaps is calculated in the binarized image using the following formula. Existence ratio of gaps (%)=(area of void portions (black portions BK))/(total area (white portions WH +black portions BK))×100

The area in the image can be calculated from the number of pixels in the SEM image.

Next, the equivalent circle diameter of gaps will be described. In the multilayer ceramic capacitor 1 of the present example embodiment, the equivalent circle diameter of gaps can preferably be set to about 1.0 μm or less, for example.

By setting the equivalent circle diameter of gaps to about 1.0 μm or less, it is possible to further improve the reliability of wire bonding performed on the external electrodes. When the size of gaps exceeds an equivalent circle diameter of about 1.0 μm, regardless of the shape of the gaps in a plan view, the reliability of wire bonding performed on the external electrodes tends to decrease. This is because, when the continuous area of a gap becomes large, the Au plated layer 3b2 tends to delaminate from the Ni plated layer 3b1 at that portion, and consequently, the wire tends to delaminate from the external electrode.

An example of a method for determining the equivalent circle diameter of gaps will be described. The existence ratio of gaps can be determined by image processing. Specifically, a line is created from the scale bar of the SEM image. Then, the diameter at the center of one void is measured. The number n of measurements is 3. Then, the average diameter of the three measurement results is taken as the equivalent circle diameter.

Next, the size per gap will be described. In the multilayer ceramic capacitor 1 of the present example embodiment, the size per gap is preferably about 1.0 μm² or less, for example.

By making the size of each gap about 1.0 μm² or less, it is possible to further improve the reliability of wire bonding performed on the external electrode. When the size of the gap exceeds about 1.0 μm², the reliability of wire bonding performed on the external electrode tends to decrease. This is because, in the portion of the gap having a size exceeding about 1.0 μm², the Au plated layer 3b2 tends to delaminate from the Ni plated layer 3b1, and consequently, the wire tends to delaminate from the external electrode.

The above-described area is acquired for the number of voids included in the SEM image, and the average area is calculated. The calculated average area is defined as the area per gap. The size of the SEM image targeted when determining the area per gap can be, for example, a size of 1387 pixels.

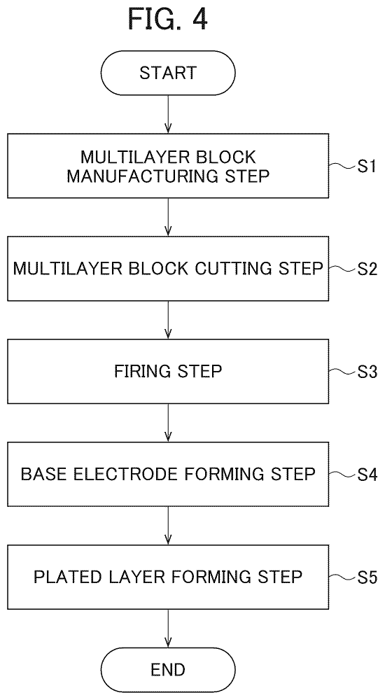

Next, an example of a method of manufacturing the multilayer ceramic capacitor 1 of the present example embodiment will be described. FIG. 4 is a flowchart explaining the method of manufacturing the multilayer ceramic capacitor 1.

Dielectric sheets for manufacturing the dielectric layers 14 and an electrically conductive paste for manufacturing the internal electrode layers 15 are prepared. The dielectric sheets and the electrically conductive paste for manufacturing the internal electrode layers 15 include a binder and a solvent. The binder and the solvent may be those known in the art.

An electrically conductive paste for the internal electrode layers 15 is printed on the dielectric sheet in a predetermined pattern by, for example, screen printing or gravure printing. Thus, the dielectric sheet in which the pattern of the first internal electrode layer 151 is formed, and the dielectric sheet in which the pattern of the second internal electrode layer 152 is formed are prepared.

By a predetermined number of the dielectric sheets on which the pattern of the internal electrode layer is not printed being laminated, a portion defining and functioning as the first outer layer portion 121 adjacent to the first surface F1 is formed. On top thereof, the dielectric sheet on which the pattern of the first internal electrode layer 151 is printed, and the dielectric sheet on which the pattern of the second internal electrode layer 152 is printed are sequentially laminated, a result of which a portion defining and functioning as the inner layer portion 11 is formed. Thereafter, a predetermined number of the dielectric sheet on which the pattern of the internal electrode layer is not printed are laminated on the portion defining and functioning as the inner layer portion 11, a result of which a portion defining and functioning as the second outer layer portion 122 adjacent to the second surface F2 is formed. Thus, a multilayer sheet is manufactured. Then, the manufactured multilayer sheet is pressed in the lamination direction T by, for example, hydrostatic pressing, thus manufacturing a multilayer block.

The multilayer block is cut into a predetermined size to cut out multilayer chips. At this time, the corner portions and ridge portions of the multilayer chip may be rounded by, for example, barrel polishing or the like.

The multilayer chip is fired to manufacture the multilayer body 2. The firing temperature depends on the materials of the dielectric layer 14 and the internal electrode layer 15. However, for example, it is preferably about 900° C. or more and about 1400° C. or less. In addition, firing may not be performed at this point, and the multilayer chip may be fired together with the base electrode layer 3a during the base electrode forming step S4 described later.

An electrically conductive paste that defines and functions as the base electrode layer 3a is applied on and around the third surface F3 and the fourth surface F4 of the multilayer body 2. In the present example embodiment, an electrically conductive paste including a glass component and a metal is applied by a method such as dipping, for example.

Thereafter, a firing treatment is performed to form the base electrode layer 3a. The temperature of the firing treatment at this time is, for example, preferably about 700° C. or more and about 900° C. or less. This firing treatment sinters the electrically conductive paste.

In the present example embodiment, the plated layer 3b includes, for example, in order from the base electrode layer 3a, the Ni plated layer 3b1 and the Au plated layer 3b2. The Ni plated layer 3b1 and the Au plated layer 3b2 are formed by electrolytic plating using, for example, a barrel plating method.

An example of a method for controlling voids formed in the Ni plated layer 3b1 will be described. The gaps between the Ni plated layer 3b1 and the Au plated layer 3b2 can be controlled by the immersion time in the plating bath and the current density when forming the Au plated layer 3b2. For example, the Au plated layer 3b2 is formed by combining electroless plating and electrolytic plating. At this time, for example, the electroless plating time is set to about 1 minute or more and about 2 minutes or less, and the current value is set to about 4.7 A as the Dk value (cathode current density value). This makes it possible to set the existence ratio of gaps to about 0.10% or less, or about 0.05% or less.

By the above manufacturing method, the multilayer ceramic capacitor 1 is manufactured in which the existence ratio of gaps, the equivalent circle diameter of the gaps, and the size per gap are within predetermined ranges.

The multilayer ceramic capacitor 1 of the present example embodiment thus manufactured is, for example, bonded such that the second external electrode 32 on the fourth surface F4 is bonded to the first land 101 provided on one surface of the substrate 100 via the electrically conductive adhesive 102, as shown in FIG. 2.

One end of the wire 202 is connected to the first external electrode 31 on the third surface F3 of the multilayer ceramic capacitor 1. The other end of the wire 202 is connected to, for example, the second land 103 other than the first land 101 to which the multilayer ceramic capacitor 1 is bonded on the substrate 100.

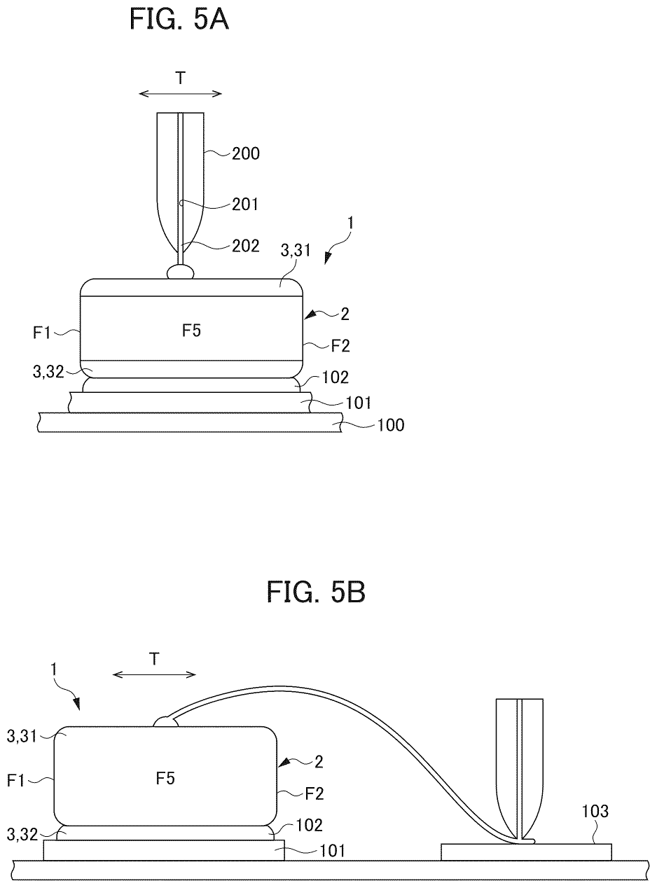

FIGS. 5A and 5B are diagrams explaining a wire bonding method. Wire bonding is performed using a bonding device including the capillary 200 having an inner hole 201 (in the drawings, only a capillary 200 is shown, and the entire device is not shown). A wire 202 is inserted into the inner hole 201 of the capillary 200, and the wire 202 can be fed out from the tip of the capillary 200.

In the present example embodiment, for example, the wire 202 is made of gold, and the outermost surface of the external electrode 3 of the multilayer ceramic capacitor 1 is the Au plated layer 3b2, so that the bonding property between the wire 202 and the external electrode 3 is improved.

The bonding device first detects the position of the external electrode 3 of the multilayer ceramic capacitor 1 by an image processing mechanism, and moves the capillary 200 onto the external electrode 3 of the multilayer ceramic capacitor 1 by a moving mechanism.

When detecting the position of the external electrode 3 of the multilayer ceramic capacitor 1 by the image processing mechanism, first, light is irradiated onto the entire substrate 100 to which the multilayer ceramic capacitor 1 is attached, and image recognition of the position of the external electrode 3 of the multilayer ceramic capacitor 1 is performed based on the reflected light from the external electrode 3.

Next, after moving the capillary 200 above the external electrode 3, the tip of the wire 202 is melted by electric discharge or the like to form a ball shape. Then, the capillary 200 is moved downward, and as shown in FIG. 5A, the ball at the tip of the wire 202 is pressure-bonded to the external electrode 3 of the multilayer ceramic capacitor 1, and one end of the wire 202 is connected onto the external electrode 3 of the multilayer ceramic capacitor 1 by applying ultrasonic waves or the like.

After connecting one end of the wire 202 onto the external electrode 3 of the multilayer ceramic capacitor 1, as shown in FIG. 5B, while feeding out the wire 202 from the inner hole 201 of the capillary 200, the capillary 200 is moved to the second land 103, and the wire 202 is pressed against the second land 103 and bonded while applying ultrasonic vibration, and then the wire 202 is cut. Thus, the external electrode 3 of the multilayer ceramic capacitor 1 is connected to the second land 103 on the substrate 100.

The structure in which the multilayer ceramic capacitor 1 is mounted on the substrate 100 as described above is referred to as a mounting structure. The mounting structure of the present example embodiment can be achieved as follows. That is, the mounting structure includes the multilayer ceramic capacitor 1 and the substrate 100. The multilayer ceramic capacitor 1 includes the multilayer body 2 and the external electrodes 31. The multilayer body 2 includes the first surface F1 and the second surface F2 opposed to each other in the lamination direction T, the third surface F3 and the fourth surface F4 opposed to each other in the first direction L intersecting the lamination direction T, and the fifth surface F5 and the sixth surface F6 opposed to each other in the second direction W intersecting the lamination direction T and the first direction L. The external electrodes 31 are each provided on a corresponding one of the third surface F3 and the fourth surface F4 of the multilayer body 2. The external electrodes 31 each include, for example, the Ni plated layer 3b1 and the Au plated layer 3b2 provided on the Ni plated layer 3b1, and gaps exist between the Ni plated layer 3b1 and the Au plated layer 3b2. The existence ratio of the gaps is, for example, about 0.05% or less. Furthermore, the multilayer ceramic capacitor 1 has a dimension in the lamination direction T that is longer than a dimension in the first direction L.

The second external electrode 32, which is the external electrode 31 on the fourth surface F4 of the multilayer body 2, is bonded to the first land 101 provided on one surface of the substrate 100 via the electrically conductive adhesive 102. Further, one end of the wire 202 is connected to the first external electrode 31, which is the external electrode 31 on the third surface F3 of the multilayer ceramic capacitor 1. On the other hand, the other end of the wire 202 is connected to the second land 103, which is a land other than the first land 101 to which the multilayer ceramic capacitor 1 is bonded on the substrate 100.

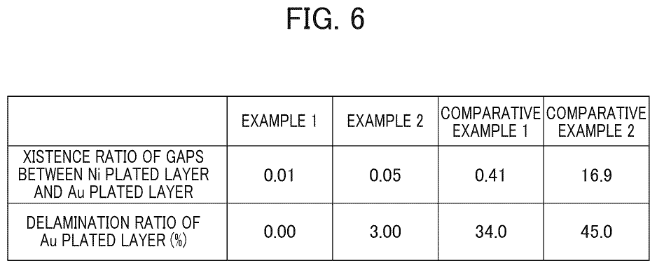

The evaluation of delamination of the Au plated layer 3b2 of the multilayer ceramic capacitor 1 of the present example embodiment will be described. FIG. 6 is a table showing evaluation results of the existence ratio of voids and the delamination rate of the Au plated layer.

The evaluation method for the delamination ratio of the Au plated layer will be described. The size of the multilayer ceramic capacitor used for evaluation was common as follows:
Dimension in the first direction L: about 0.4 mm
Dimension in the second direction W: about 0.2 mm
Dimension in the lamination direction T: about 0.2 mm
One hundred multilayer ceramic capacitors for each of Example 1, Example 2, Comparative Example 1, and Comparative Example 2 were prepared, each example having different existence ratios of gaps between the Ni plated layer and the Au plated layer.

One hundred multilayer ceramic capacitors of each example and each comparative example were arranged and fastened to a substrate. The method of fastening is not particularly limited. Such a method for fastening prevents the multilayer ceramic capacitor from delaminating from the substrate during the Au plating delamination test with a tape, which will be described later. An example of the fastening method is fastening with an adhesive.

Next, an adhesive tape was applied to the one hundred multilayer ceramic capacitors arranged and fastened on the substrate for each example and each comparative example. The adhesive tape was bonded so as to cover the Au plated layer. The adhesive tape was, for example, available from 3M, product number T5625, yellow, or an adhesive tape having equivalent adhesive strength.

After bonding the adhesive tape, the adhesive tape was peeled off at once. After peeling off the tape, it was confirmed with a microscope whether the Au plated layer was peeled off.

As shown in FIG. 6, in Example 1 where the existence ratio of gaps was about 0.01% and Example 2 where the existence ratio of gaps was about 0.05%, the delamination ratios of the Au plated layer were 0.00% and 3.00%, respectively, and the delamination of the Au plated layer was reduced or prevented. That is, the reliability of wire bonding to the external electrode was improved.

In contrast, in Comparative Example 1 having the existence ratio of gaps of about 0.41% and Comparative Example 2 having the existence ratio of gaps of about 16.9%, delamination of the Au plated layer was observed frequently, with the delamination ratios of the Au plated layer being 34.0% and 45.0%, respectively. That is, the reliability of wire bonding to the external electrodes was low.

As shown in FIG. 6, it was confirmed that by setting the existence ratio of gaps to about 0.05% or less, delamination of the Au plated layer was reduced or prevented and the reliability of wire bonding was improved.

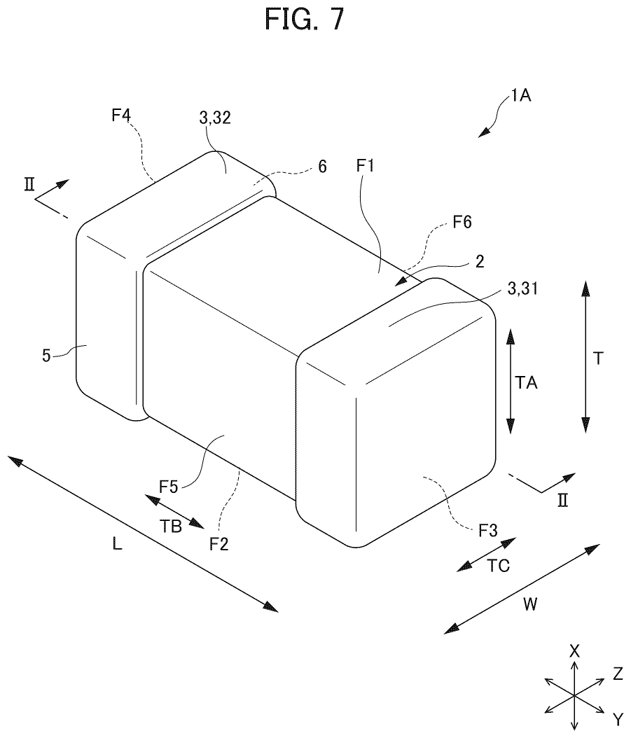

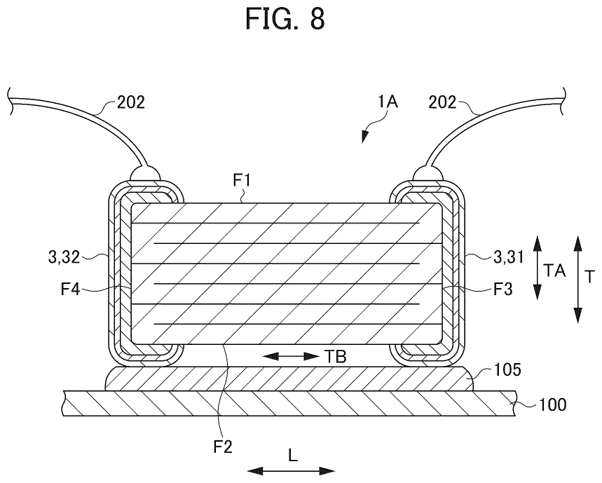

A multilayer ceramic capacitor 1A according to another example embodiment of the present invention will be described with reference to FIGS. 7 and 8. FIG. 7 is a schematic perspective view of the multilayer ceramic capacitor 1A of another example embodiment. FIG. 8 is a cross-sectional view taken along the line II-II of the multilayer ceramic capacitor 1A in FIG. 7, and also shows a state where the multilayer ceramic capacitor 1A is mounted on the substrate 100 and wire-bonded.

In the multilayer ceramic capacitor 1 described above with reference to FIGS. 1 and 2, the second external electrode 32 adjacent to the fourth surface F4 is bonded to the first land 101 provided on one surface of the substrate 100 via the electrically conductive adhesive 102, for example, by the electrically conductive adhesive 102. However, the multilayer ceramic capacitor 1 is not limited to this.

As shown in FIGS. 7 and 8, in the multilayer ceramic capacitor 1A of the present example embodiment, the dimension in the lamination direction T is shorter than the first direction L in which the external electrodes 3 are provided at both ends as illustrated.

As shown in FIG. 7, the external electrodes 3 of the multilayer ceramic capacitor 1A of the present example embodiment each extend further on the first surface F1, the second surface F2, the fifth surface F5, and the sixth surface F6 than the multilayer ceramic capacitor 1 of the above-described example embodiment.

In other configurations, the multilayer ceramic capacitor 1A is the same or substantially the same as the multilayer ceramic capacitor 1 of the above-described example embodiment and, therefore, descriptions of the same portions will be omitted. That is, the external electrode 31 and the external electrode 32 of the multilayer ceramic capacitor 1A of the present example embodiment each include a base electrode layer and a plated layer, and the existence ratio of gaps is about 0.10% or less, preferably about 0.05% or less, for example.

As shown in FIG. 8, the second surface F2 of the multilayer ceramic capacitor 1A of the present example embodiment is bonded to the first land 101 provided on one surface of the substrate 100, for example, by an epoxy resin 105. The wires 202 extend from both the external electrode 31 and the external electrode 32, each extending on the first surface F1.

In the multilayer ceramic capacitor 1A of the present example embodiment as well, similar to the multilayer ceramic capacitor 1 of the above-described example embodiment, the reliability of wire bonding to the external electrodes can be improved during wire bonding.

The mounting structure of the multilayer ceramic capacitor 1A of the present example embodiment can be achieved as follows. That is, the mounting structure includes the multilayer ceramic capacitor 1A and the substrate 100. The multilayer ceramic capacitor 1A includes the multilayer body 2 and the external electrodes 31. The multilayer body 2 includes the first surface F1 and the second surface F2 opposed to each other in the height direction TA, the third surface F3 and the fourth surface F4 opposed to each other in the lateral direction TB intersecting the height direction TA, and the fifth surface F5 and the sixth surface F6 opposed to each other in the width direction TC intersecting the height direction TA and the lateral direction TB. The external electrodes 31 are each provided on a corresponding one of the third surface F3 and the fourth surface F4 of the multilayer body 2, the external electrodes 31 are each further provided on the first surface F1, the second surface F2, the fifth surface F5, and the sixth surface F6 continuing from the third surface F3 or the fourth surface F4, the external electrode 31 includes, for example, the Ni plated layer 3b1 and the Au plated layer 3b2 provided on the Ni plated layer 3b1, gaps exist between the Ni plated layer 3b1 and the Au plated layer 3b2, and the existence ratio of gaps is about 0.05% or less, for example. Furthermore, the multilayer ceramic capacitor 1A has a dimension in the height direction TA that is shorter than a dimension in the lateral direction TB.

Here, the height direction TA refers to a direction along a direction perpendicular or substantially perpendicular to a plane of the multilayer ceramic capacitor 1A when the multilayer ceramic capacitor 1A is placed on the plane such as the substrate 100. In addition, the lateral direction TB refers to a direction in which the external electrode 31 and the external electrode 32 are opposed to each other in the multilayer ceramic capacitor 1A. FIG. 7 shows the height direction TA, the lateral direction TB, and the width direction TC when the multilayer ceramic capacitor 1A is placed on the YZ plane in the Cartesian coordinate system.

In FIG. 8, the height direction TA and the lamination direction T are parallel or substantially parallel. However, depending on how the multilayer ceramic capacitor 1A is placed, the height direction TA and the width direction W may be parallel or substantially parallel.

The second surface F2 of the multilayer ceramic capacitor 1A is bonded to the first land 101 provided on one surface of the substrate 100 by, for example, a resin such as an epoxy resin 105. The wires 202 extend from both the external electrode 31 and the external electrode 32, each extending on the first surface F1. That is, one end of each of the wires 202 respectively extends from the external electrode 31 extending from the third surface F3 to the first surface F1 and the external electrode 32 extending from the fourth surface F4 to the first surface F1. The other end of each of the wires 202 is connected to a different land provided on one surface of the substrate 100.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer electronic component comprising:
a multilayer body including a first surface and a second surface opposed to each other in a lamination direction, a third surface and a fourth surface opposed to each other in a first direction intersecting the lamination direction, and a fifth surface and a sixth surface opposed to each other in a second direction intersecting the lamination direction and the first direction; and
external electrodes each located on a corresponding one of the third surface or the fourth surface of the multilayer body; wherein
the external electrodes each include a Ni plated layer and an Au plated layer on the Ni plated layer;
gaps exist between the Ni plated layer and the Au plated layer; and
an existence ratio of the gaps is about 0.05% or less.

2. The multilayer electronic component according to claim 1, wherein an equivalent circle diameter of the gaps is about 1.0 μm or less.

3. The multilayer electronic component according to claim 1, wherein each of the gaps has a size of about 1.0 μm² or less.

4. The multilayer electronic component according to claim 1, wherein a thickness of the Au plated layer is about 0.3 μm or more and about 1.1 μm or less.

5. The multilayer electronic component according to claim 1, wherein a dimension in the lamination direction is greater than a dimension in the first direction.

6. The multilayer electronic component according to claim 1, wherein the gaps are located in void portions of the Ni plating layer.

7. The multilayer electronic component according to claim 1, wherein the existence ratio of the gaps is about 0.01% or more and about 0.05% or less.

8. The multilayer electronic component according to claim 1, wherein each of the external electrodes includes a base electrode layer on which the Ni plated layer and the Au plated layer are provided.

9. The multilayer electronic component according to claim 8, wherein each of the base electrode layers includes a metal component and a glass component.

10. The multilayer electronic component according to claim 8, wherein each of the base electrode layers include Cu as a main component.

11. A multilayer electronic component comprising:
a multilayer body including a first surface and a second surface opposed to each other in a height direction, a third surface and a fourth surface opposed to each other in a first direction intersecting the height direction, and a fifth surface and a sixth surface opposed to each other in a second direction intersecting the height direction and the first direction; and
external electrodes each located on a corresponding one of the third surface or the fourth surface of the multilayer body; wherein
the external electrodes extend onto the first surface, the second surface, the fifth surface and the sixth surface, in addition to the third surface or the fourth surface;
the external electrodes on the first surface each include a Ni plated layer and an Au plated layer on the Ni plated layer;
gaps exist between the Ni plated layer and the Au plated layer; and
an existence ratio of the gaps is about 0.05% or less.

12. The multilayer electronic component according to claim 11, wherein an equivalent circle diameter of the gaps is about 0 μm or less.

13. The multilayer electronic component according to claim 11, wherein each of the gaps has a size of about 1.0 μm² or less.

14. The multilayer electronic component according to claim 11, wherein a thickness of the Au plated layer is about 0.3 μm or more and about 1.1 μm or less.

15. The multilayer electronic component according to claim 11, wherein a dimension in the lamination direction is greater than a dimension in the first direction.

16. The multilayer electronic component according to claim 11, wherein the gaps are located in void portions of the Ni plating layer.

17. The multilayer electronic component according to claim 11, wherein the existence ratio of the gaps is about 0.01% or more and about 0.05% or less.

18. The multilayer electronic component according to claim 11, wherein each of the external electrodes includes a base electrode layer on which the Ni plated layer and the Au plated layer are provided.

19. The multilayer electronic component according to claim 18, wherein each of the base electrode layers includes a metal component and a glass component.

20. The multilayer electronic component according to claim 18, wherein each of the base electrode layers include Cu as a main component.
